(19) United States
(12) Patent Application Publication
(10) Pub. No.: US 2008/0261500 A1
(43) Pub. Date: Oct. 23, 2008

(54) Foodstuff Product, Particularly a Sausage Product, Arrangement and Method For the Production Thereof, and Casing For the Product

(75) Inventors: Jens Fogler, Taunusstein (DE); Herbert Gord, Ingelheim (DE); Gerhard Grolig, Morfelden-Walldorf (DE)

Correspondence Address: GUDRUN E. HUCKETT DRAUDT, SCHUBERTSTR. 15A, WUPPERTAL, 42289, DE

(73) Assignee: KALLE GMBH, Wiesbaden (DE)

(21) Appl. No.: 11/569,089

(22) PCT Filed: May 12, 2005
(86) PCT No.: PCT/EP2005/005116

§ 371 Date: Nov. 14, 2006

(30) Foreign Application Priority Data
May 14, 2004 (DE) 10 2004 024 419.7

(51) Int. Cl. A22C 11/02

(52) U.S. Cl. 452/31

(57) ABSTRACT

An arrangement for producing foodstuff products with pasty stuffing has a stuffing device having a stuffing tube. A casing to be stuffed through the stuffing tube draws additional casing material from a supply as it is being stuffed. A sensor device recognizes spaced-apart markings of the casing. When markings reach an activation position, the sensor device sends an activation signal. A closing device closes the end of the already stuffed casing and the beginning of the next casing to be stuffed. An immobilization brake has a stop position in which drawing of the casing is prevented. A first connection connects sensor device and immobilization brake. A second connection connects stuffing device and immobilization brake. The activation signal causes the immobilization brake to remain in the stop position until the stuffing device sends a termination signal to the immobilization brake that indicates completion of stuffing of a preset stuffing quantity.

The invention relates to a foodstuff product with pasty stuffing, in particular a sausage product, according to the preamble of claim 34, an arrangement according to the preamble of claim 1, and a method according to the preamble of claim 16 as well as a casing according to the preamble of claim 18.

The stuffing of hose-shaped casings with a pasty a stuffing is known, in particular, in connection with sausage production. Here, the stuffing, for example, sausage meat, is filled into a stuffing device from which the stuffing is filled through a stuffing tube into a hose-shaped casing that is closed at the beginning. The casing surrounds the stuffing tube at least partially. The casing area that is being filled draws additional casing material from a supply as a result of the momentum of the stuffing process. Since the casing material is usually easily slidable on the stuffing tube, the drawing of the casing is usually restricted. For this purpose, a casing brake has been developed that surrounds the stuffing tube and the casing arranged thereon annularly and that presses the casing material with minimal, always constant pressure against the stuffing tube. After the desired quantity of stuffing has been filled in, a closing device is activated that closes off and then separates from one another the end of the now stuffed casing and the beginning of the next casing portion to be stuffed. The stuffing process then begins again.

The stuffing quantity of sausage products produced in this way and containing a pasty stuffing is always the same. However, since the diameter of the hose-shaped casing fluctuates slightly, the length of the finished sausage product and of the casing material used for its production differs. In certain cases, however, the production of sausage products of constant length is desired.

DE 36 08 983 C2 discloses an arrangement for producing sausage products with an applied printed image. The printed image must be differentiated from scatter prints. In the case of scatter printing, the same print design is applied at relatively short distances on a continuous casing supply and the individual sausage products produced therefrom have the same print design usually several times and some print designs only partially. In contrast to this, in the case of printed images, the sausage products have generally only one printed image and this printed image is always complete.

The printed image on the sausage product in DE 36 08 983 C2 has always the same spacing from the ends of the sausage product. For this purpose, spaced-apart markings are provided on the hose-shaped casing material for producing the sausage products; during the course of movement of the casing in the stuffing direction, the markings reach an activation position and are recognized thereat by a sensor device. At the activation position, the stuffing process is interrupted, respectively, and the end of the already stuffed casing and the beginning of the casing to be stuffed next are closed and then separated from one another. The length of the casing material for producing such sausage products is always constant but the sausage products have the disadvantage of a fluctuating stuffing quantity because the diameter of the casing hose varies slightly.

The invention concerns the problem of developing a foodstuff product with pasty stuffing, in particular a sausage product, according to the preamble of claim 34, which sausage product has an increased consumer acceptance; of providing an arrangement and a method for its production; and of making available a casing, in particular for use in the arrangement and/or the method.

The invention solves this problem by a foodstuff product with the features of claim 34, by an arrangement having the features of claim 1, and by a method having the features of claim 16 as well as a casing having the features of claim 18.

The arrangement according to the invention has a casing and an immobilization brake wherein the immobilization brake can assume a stop position in which drawing of the casing is completely prevented and wherein the immobilization brake is connected by means of a first connection to the sensor device and by means of a second connection to the stuffing device. In the stop position of the immobilization brake it is possible to continue the stuffing process until a predetermined stuffing quantity has been reached without this causing additional casing material to be simultaneously drawn from the supply. In this connection, the casing expands in particular in the radial direction. As soon as a marking has reached the activation position, the sensor device transmits through the first connection an activation signal to the immobilization brake and the immobilization brake moves into the stop position. The stuffing device through the second connection sends a termination signal to the immobilization brake only once a predetermined stuffing quantity has been reached and the immobilization brake then moves away from the stop position. In this connection, the predetermined stuffing quantity can correspond to the final stuffing quantity of the foodstuff product or to portions of the final stuffing quantity. The length of the employed casing material and the stuffing quantity are identical for each foodstuff product produced in this way. In this way, a standardization of the length and of the stuffing quantity of the foodstuff product is possible so that consumer acceptance is increased.

One embodiment of the invention provides that the stuffing device has a control for the stuffing quantity and the control is connected to the immobilization brake by means of the second connection and by means of a third connection to the sensor device. In this way, it is possible to synchronize the stopping action of the drawing movement at defined positions and the stuffing quantity that is desired up to this position. This is in particular advantageous when the closing device is not to be activated at each marking or in connection with each activation signal.

The stuffing quantity that can be preset in the control can depend, for example, on the number of markings that have already passed the activation position since beginning of production of the foodstuff product currently being produced. In the case of a substantially cylindrical foodstuff product whose beginning and end coincide with a marking and that is divided by the applied markings substantially into four identically sized cylinders, for the first marking that triggers an activation signal after closing off the beginning of the casing a stuffing quantity of 25% of the final stuffing quantity; for the second marking a stuffing quantity of 50% of the final stuffing quantity; for the third marking a stuffing quantity of 75% of the final stuffing quantity; and for the fourth marking the final stuffing of the finished foodstuff product can be preset. Subsequently, the counting action begins anew. Depending on the consistency of the stuffing, the shape of the foodstuff product, or other manufacturing conditions, it can also be expedient that the predetermined stuffing quantity deviates from this linear stuffing quantity so that in this way the stuffing result as a whole is improved.

By means of this embodiment of the arrangement, it is possible to divide the stopping action of the casing that occurs when a predetermined stuffing quantity is reached into several stops/additional stuffing processes within a foodstuff product length; in this way, a more uniform tautness of the stuffed casing and thus of the foodstuff product can be achieved as well as a more uniform expansion of the casing across the entire length of the foodstuff product.

As an alternative or in addition to this embodiment, markings of different types can be applied on the casing wherein the type of a marking depends on the spacing to at least one additional marking. The type of marking is recognized by the sensor device and is signaled by means of the third connection to the control of the stuffing device. In this connection, the type of marking indicates to the control the predetermined stuffing quantity; the stuffing quantity can be the final stuffing quantity of the foodstuff product so that the marking is a kind of main marking or final marking or the predetermined stuffing quantity can also correspond to a portion of the final stuffing quantity and the corresponding marking therefore represents a type of intermediate marking. Each intermediate marking is applied on the casing expediently between two main markings. When one intermediate marking reaches the activation position, the drawing action of the casing is interrupted completely by means of the immobilization brake assuming the stop position until the portion of the final stuffing quantity that is correlated with the intermediate marking and has been input in the control of the stuffing device has been filled in. However, the closing device is not yet activated because the final stuffing quantity has not yet been filled in.

The different types of markings can be, for example, in the form of different colors for the markings that are detected and differentiated by the sensor device. The type can also be determined by different electromagnetic properties of the markings or other types of differentiations.

The invention preferably has a casing brake that allows a braked drawing action of the casing in a drawing position and thus increases the stuffing pressure at which pressure the casing of the foodstuff product is stuffed. In a preferred embodiment of the invention the casing brake and the immobilization brake are the same or the casing brake is integrated so that the immobilization brake can be moved into the stop position as well as into the drawing position.

Moreover, all listed connections not only can extend directly but also indirectly through other components of the arrangement. For example, the second connection, could be designed such that the stuffing device signals the termination signal by means of the sensor device or the closing device to the immobilization brake. Or the connections are entirely or partially first combined in a control device or a distributor and from there they extend to the receiver, respectively. Numerous other indirect connection types are also usable and can simplify and/or improve the control technology of the arrangement

In a preferred embodiment of the arrangement, the stuffing device has one or several additional stuffing tubes that are not in a stuffing position. Only the stuffing tube that is in the stuffing position is actively participating in the stuffing operation. The additional stuffing tubes are provided with new casing supply and are thus prepared for the stuffing process. As soon as the casing supply of the active stuffing tube that is in the stuffing position has been used up, the stuffing tube that is in the stuffing position is moved away from this position and one of the additional stuffing tubes is transferred into the stuffing position. The rearrangement of the stuffing tubes is realized preferably by a pivot movement. During the pivot movement, all stuffing tubes perform a movement on the same circular path. When the stuffing device, for example, is provided with two stuffing tubes, the two stuffing tubes carry out during pivoting a circular movement about 180° on the same circular path.

In an advantageous configuration, the sensor device has at least two sensors that are spaced from one another preferably substantially uniformly about the stuffing tube. When the sensor device is provided with two sensors, they are positioned preferably precisely opposed to one another. By means of the arrangement of at least two sensors in connection with a completely circumferentially extending marking on the casing, the sensor device can be advantageously switched such that an activation signal is triggered only once all sensors have detected the marking. In this way, it is ensured that the sensor device does not falsely detect structures or colors present on the casing, in particular, a print applied to the casing and not designed as a marking.

The sensors are preferably designed to be movable toward the stuffing tube and away from it. In this way, loading of the stuffing tube with a new casing supply is simplified. When the stuffing device has more than one stuffing tube, wherein all stuffing tubes are movable on the same circular path, the sensors of the sensor device can be moved away from the stuffing tube currently in the stuffing position and into a position external to the circular path of the stuffing tube. In this way, the sensors do not hinder the pivoting action of the stuffing tubes. Of course, the sensor movability can be provide also in a configuration of a sensor device with only one sensor.

The casing of the arrangement has a σ₅ value in the range of 0.3 to 25 N/mm², preferably in the range of 1.2 to 10 N/mm² and particularly preferred in the range of 2 and 5 N/mm². The σ₅ value (tensile stress value) refers to the tensile stress σ at an expansion of 5%. In this connection, the tensile stress is the tensile force relative to the smallest measured initial cross-section of a test specimen at any point in time of the experiment. The measurement of the σ₅ value is realized in accordance with DIN standard 53455 of the watered casing and in transverse direction relative to the foodstuff product to be produced with the casing, i.e., with regard to its radial expansion. Surprisingly, it was found that in particular this range of the σ₅ value ensures proper operation of the arrangement as a whole. For a reduced σ₅ value, the foodstuff products can become wrinkled and do not reach the tautness desired by the consumer in the subsequent processes, for example, when being cooked or smoked. Also, a uniform stuffing is made more difficult. It was found that at larger σ₅ values the casing of the foodstuff product can burst during continued stuffing with the immobilization brake in the stop position and thus during radial expansion of the casing. The lack of tautness as well as bursting are not desirable. The casing with these special σ₅ values is matched in a targeted way to the interaction in the arrangement with the immobilization brake and the continued stuffing in the stop position of the immobilization brake.

It is particularly advantageous when the σ₅ value of the casing across the entire length of the casing supply has a tolerance of less than +/−5%. In this way, the foodstuff products produced with the casing have a uniform tautness and a uniform diameter.

Spaced-apart repeated markings are applied to the casing and are preferably spaced at a uniform spacing. In an advantageous embodiment of the sleeve, the markings extend at least substantially annularly about the entire circumference of the foodstuff product produced with the casing. In this way, the detection of the markings by means of the sensor devices of the arrangement is significantly improved. The markings are applied expediently transversely to the longitudinal extension of the casing.

The marking can be also of the type of a conventional color print. The color of the marking advantageously is set apart from the color of the casing and of elements that are applied to the casing. In this way, false triggering of the sensor device can be prevented. It was surprisingly found that the use of a yellowish textile casing with a predominantly green printed image and a dark blue marking is suitable in particular for detection by the sensor device. It is however also possible that the marking is comprised of a color that is visible only when exposed to UV light or is fluorescent or contains metal-containing pigments. Also, the marking can be comprised of several thin lines like a bar-code and can contain additional information. Another possible type of marking can be comprised of a foamed structure that is set apart from the remaining casing surface. The type of the markings applied to the casing can be uniform or different wherein the different types of markings provide additional information with which, for example, the stuffing quantity for this type of marking can be set.

In an advantageous embodiment of the invention, the casing has a carrier material. The carrier material can be a fabric, woven material, compacted nonwoven, or spunbond material of natural fibers, synthetic fibers or mixtures thereof. As natural fibers, in particular cotton fibers, cellulose fibers, wool or silk can be used. Preferably, the carrier material is coated on one side or both sides or is surface-treated in other ways. The coating is done preferably with an acrylate resin, a plastic material blend, polyvinyl acetate, silicone dispersion or regenerated cellulose as well as mixtures of these compounds. Surprisingly, it was found that because of the coating conditions as well as stretching of the carrier material as well as the combination of carrier material and coating medium the casing can be adjusted in a targeted way to the desired σ₅ value. The casing with the carrier material has preferably a thickness of 50 to 200 μm.

The casing can also be comprised of a single-layer or multi-layer material on the basis of a polymer. Depending on the employed material, the casing in this case has preferably a wall thickness of 20 to 180 μm. Alternatively, a casing on the basis of cellulose hydrate with or without carrier material can be used also.

In an advantageous embodiment of the invention, the casing has at least one printed image repeated at a uniform spacing. In this connection, the marking can be part of the printed image. In this way, the marking as such is not recognizable by the consumer on the finished foodstuff product. In order to increase the quality of the printed image, in particular in the case of a casing with a textile carrier material, the printed image is preferably applied onto a base coat. In the case of textile carrier material, the textile material can be entirely or partially calendered so that it has a smoother surface.

The casing is in the form of a hose immediately before being stuffed. In this way, the casing supply can already be formed as a hose and during production of the foodstuff packagings is then positioned on the stuffing tube of the arrangement so as to surround it. However, the casing can also be present as a flat material that is formed to a hose only once it has been placed onto the stuffing tube and then fixed by gluing or welding.

The marking and/or the printed image is preferably printed onto the surface of the casing. Alternatively, the marketing and/or the printed image can already be printed on the carrier material of the casing before the hose is produced wherein the carrier material is subsequently provided with a transparent coating through which the print can be seen. In this way, the more complex printing on the finished casing is eliminated.

The casing that has been formed to a hose has preferably a substantially cylindrical shape. However, any other shape, for example, shapes with fat ends or a wave shape can be provided.

Further advantages and details of the invention result from the dependent claims and the embodiments illustrated schematically in the drawings and explained in the following. It is shown in:

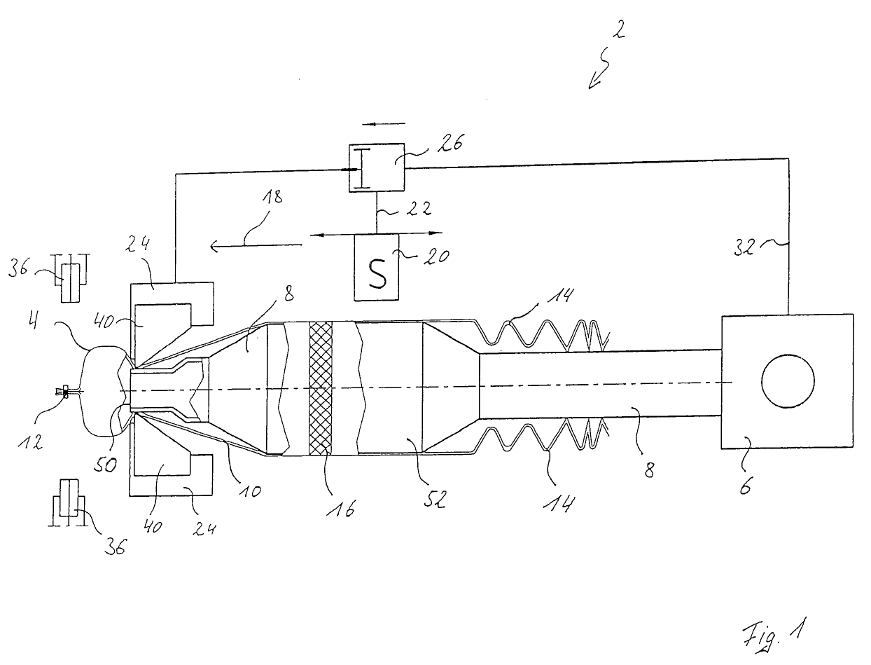

FIG. 1 an arrangement according to the invention in partially sectioned illustration at the beginning of the production process of a foodstuff product;

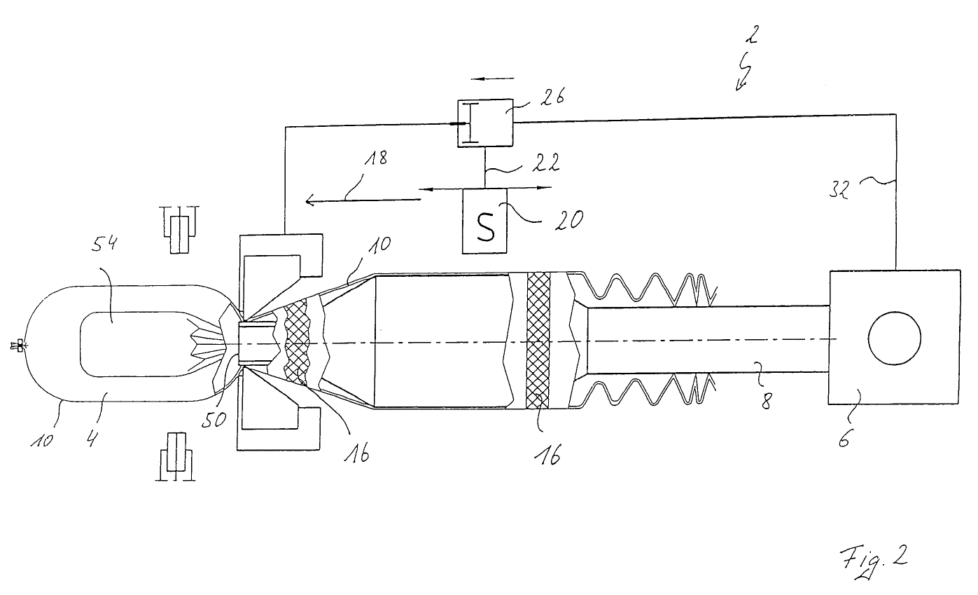

FIG. 2 an arrangement according to FIG. 1 with farther advanced stuffing;

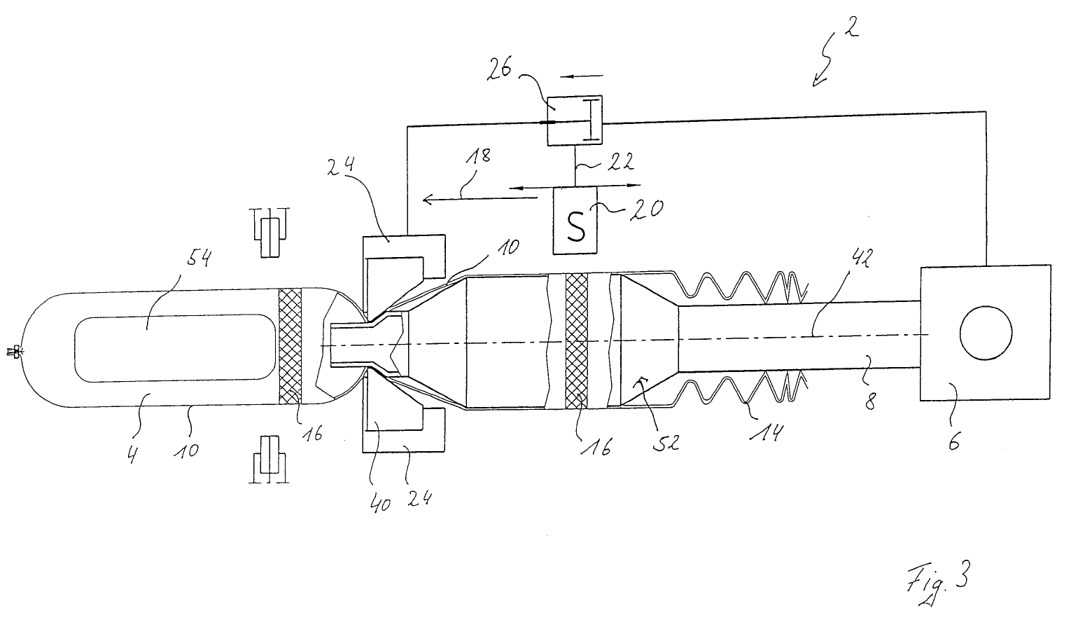

FIG. 3 an arrangement according to FIG. 1 with the immobilization brake in stop position;

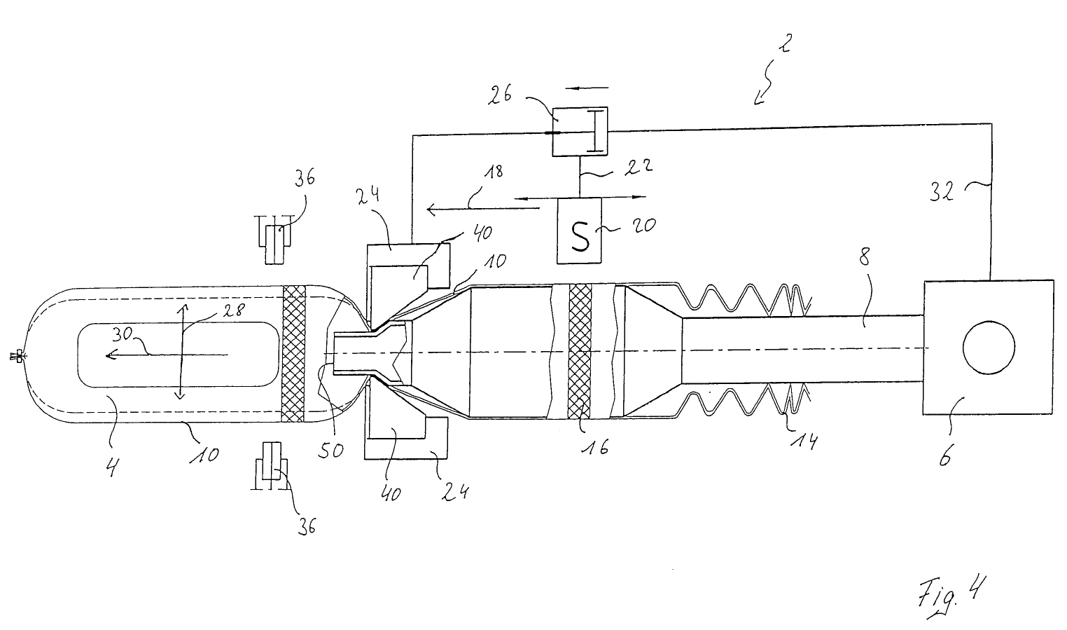

FIG. 4 an arrangement according to FIG. 3 with radially expanded casing of the foodstuff product;

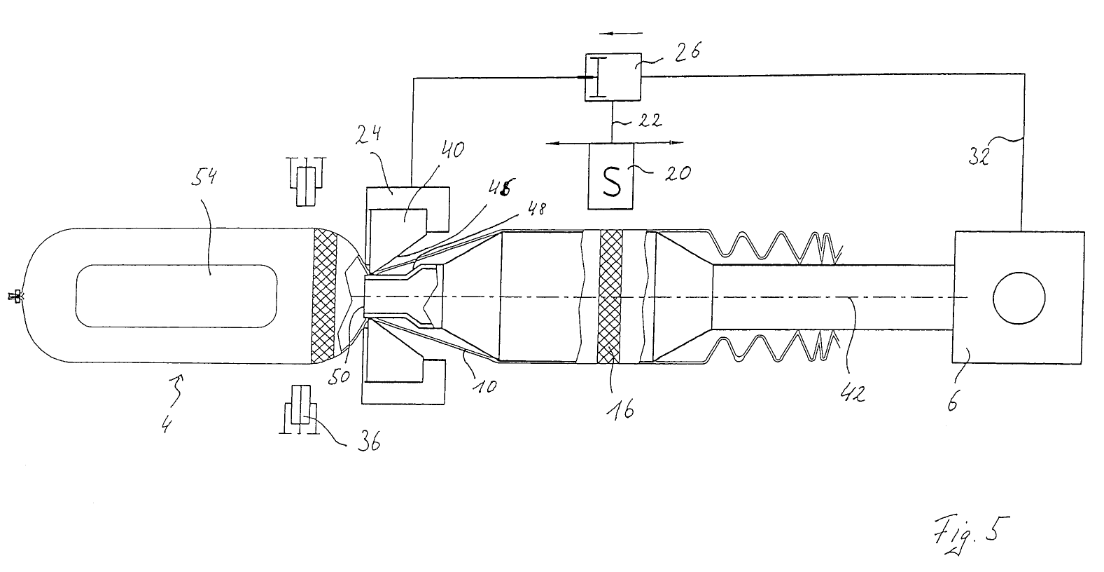

FIG. 5 an arrangement according to FIG. 4 with the immobilization brake in the drawing position;

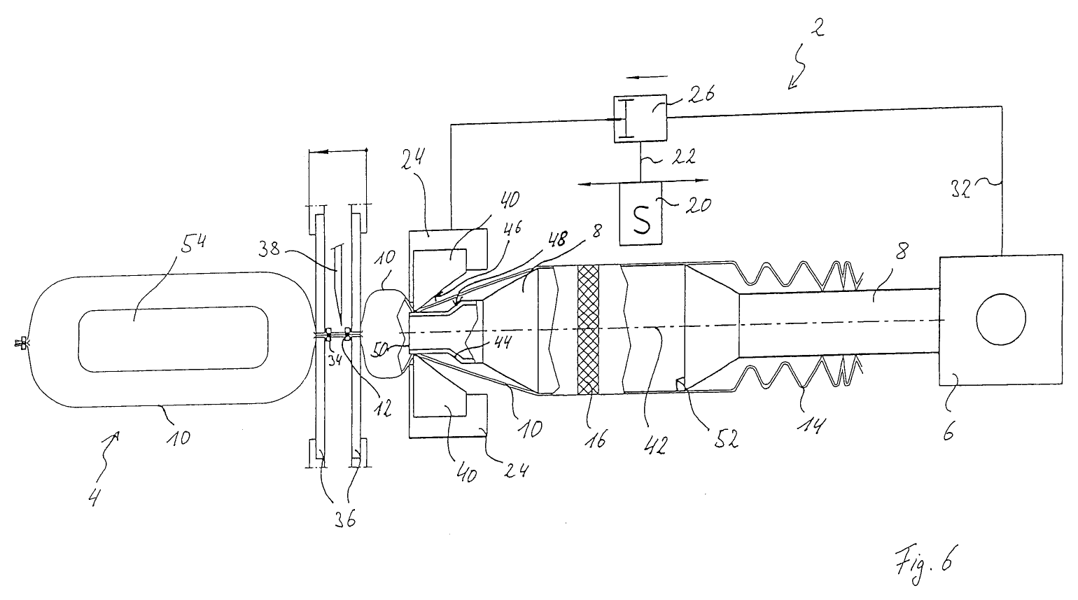

FIG. 6 an arrangement according to FIG. 5 during closing and separation of the end of the casing that has been stuffed and of the beginning of the next casing to be stuffed;

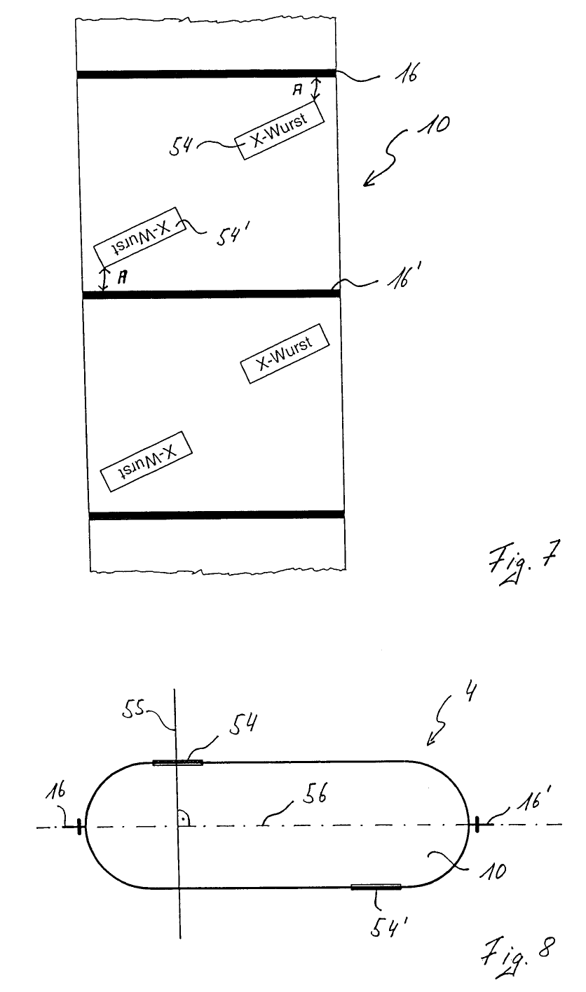

FIG. 7 a casing according to the invention in the unrolled state;

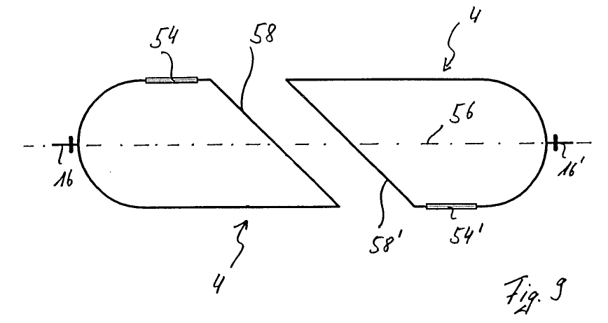

FIG. 8 a longitudinal section of a foodstuff product according to the invention in a side view; and

FIG. 9 a foodstuff product according to the invention in accordance with FIG. 8 cut in half by a cut that has been applied at a slant to the longitudinal axis of the foodstuff product.

FIGS. 1 through 6 show as a whole an arrangement 2 according to the invention in sequential working positions during the production of a foodstuff product 4 and illustrate thus also one embodiment of the method according to the invention. The beginning of manufacture of the foodstuff product is illustrated in FIG. 1. The arrangement 2 has a stuffing device 6 with a stuffing tube 8 from which stuffing, not illustrated in the drawings, is to be stuffed into a hose-shaped casing 10 with closed beginning 12.

In this connection, the stuffing material has a pasty consistency wherein pasty is to be understood such that the stuffing within the foodstuff product 4 is comprised of several parts that during stuffing of the casing 10 can slide past one another. The parts can also be solid. The stuffing can be, for example, sausage meat or another mushy material but can also be of a flour-like, grainy or pea-like consistency as well as size.

During stuffing of the casing 10 additional casing material is drawn from a supply 14. The supply 14 can already be formed as a hose and is then available preferably in a folded shape, for example, like an accordion, wherein the supply 14 of the hose-shaped casing 10 is pushed onto the stuffing tube 8. The supply 14 can be also in the form of a flat film that is formed and welded to a hose on the stuffing tube 8. The latter variant is not illustrated in the drawings.

Markings 16 are repeated on the casing 10 at a spacing; during the stuffing of the casing 10, the markings move along the stuffing tube 8 (FIG. 2) as a result of drawing of the casing in the stuffing direction 18. In this connection, the markings 16 reach an activation position (FIG. 3) in which they are recognized by a sensor device 20, respectively. The sensor device 20 then sends an activation signal through a first connection 22 to the immobilization brake 24 having an actuator 26 so that the immobilization brake 24 will move into a stop position that completely prevents drawing of the casing 10 (FIGS. 3 and 4). The stuffing process is not interrupted when doing so. As an actuator 26, hydraulic or pneumatic cylinder arrangements of known configuration are provided in particular. Since in the stop position of the immobilization brake 24 no additional casing material 10 is removed from the supply 14, the casing 10 of the foodstuff product 4 that is currently in production will expand. The expansion of the casing 10 is illustrated in FIG. 4 by the initial shape of the foodstuff product 4 shown in dashed lines and the expanded diameter shape of the foodstuff product 4 shown in solid lines. The expansion of the casing 10 is realized in particular in the radial direction 28 of the foodstuff product 4.

Only when a predetermined quantity has been filled in, the stuffing device 6 will send a termination signal to the immobilization brake 24 by means of the second connection 32 in order to move away from the stop position (FIG. 5).

As illustrated in FIG. 6, subsequently the end 34 of the casing 10 that has just been stuffed as well as the beginning 12 of the casing 10 to be stuffed next are closed. For this purpose, preferably a closing device 36 is used which operates by double-clip methods. Of course, it is also possible to employ other conventional closing devices. The end 34 of the casing 10 that has been stuffed and the beginning 12 of the casing 10 to be stuffed next can remain connected to one another or they are separated from one another by means of a separating knife 38.

In order to slow down the removal of casing 10 during the stuffing operation, the arrangement can comprise a casing brake that slows or brakes the removal in a drawing position but does not stop it. Preferably, the casing brake is the same as the immobilization brake 24 as illustrated in the Figures. The immobilization brake 24 can then assume the drawing position (FIGS. 1 and 2 as well as FIGS. 5 and 6) as well as the stop position (FIGS. 3 and 4).

The immobilization brake 24 has a pressing element 40 that presses the casing 10 radially against the stuffing tube 8 in the drawing position. For moving into the stop position, the pressing element 40 is configured to be movable parallel to the longitudinal axis 42 of the stuffing tube 8 in the direction toward a contact area 44 of the stuffing tube 8; in the stop position, it forces the casing 10 against this contact area 44 (FIGS. 3 and 4). In this connection, the pressing element 40 is preferably annular and has a pressing surface 46 that is advantageously arranged essentially parallel to a contact surface 48 of the contact area 44 and contacts in the stop position areally the contact surface 48. The contact surface 46 and the contact surface 48 are preferably conical.

During the movement of the pressing element 40 from the drawing position of the immobilization brake 24 into the stop position and during the subsequent return movement, stuffing material that is located externally within the stuffing flow is simultaneously conveyed in the area of an opening 50 of the stuffing tube 8 into the interior of the sausage. By means of this process, referred to in the field of sausage production as turning inside out the stuffing or sausage meat, an undesirable streak formation caused by grease in the interior of the foodstuff product 4 directly underneath the casing 10 can be prevented reliably.

In the area of the activation position, on the stuffing tube 8 a smoothing device 52 is arranged that smoothes the casing material 10 before it passes the sensor device 20 so that in this way the recognition of the marking 16 by the sensor device 20 is improved. This smoothing device 52 is preferably a core pushed onto the stuffing tube 8 and provided with a cylindrical outer diameter that corresponds essentially to the inner diameter of the un-expanded casing material 10. The casing material 10 is provided with a printed image 54 that is repeated at regular spacings and has on the finished foodstuff product 4 always the same spacing to the ends or beginnings 12 and the end 34 off the foodstuff product 4 (FIG. 6). The markings 16 can be provided by the printed images 54.

The first connection 22 and the second connection 32 can be electrical and/or electronic as well as mechanical or hydraulic connections. The position of the sensor device 20 is preferably adjustable essentially parallel to the longitudinal axis 42 of the stuffing tube 8. Moreover, the position of the activation position of the markings 16 can also be selected and can be matched to the different foodstuff product lengths.

FIG. 7 shows the casing 10 according to the invention in a developed state, i.e, in a shape not formed to a hose. The area between two markings 16, 16′ determines the circumferential surface of the foodstuff product 4 to be produced from the casing 10. Between two markings 16, 16′ two identical printed images 54, 54′ are applied which each have the same spacing A to the markings 16, 16′ that are proximal to them. Moreover, the orientation of the two printed images 54, 54′ is mirror-symmetrical to one another, i.e., rotated by 180° about a straight line 55 which intersects the longitudinal axis 56 of the foodstuff product 4 at a right angle. As illustrated in FIG. 8, the circumferential position of the two printed images 54, 54′ on the foodstuff product 4 produced with the casing 10 is precisely opposite.

With this arrangement of the two printed images 54, 54′ on the casing 10 it is possible to obtain two identical halves (FIG. 9) from the foodstuff product 4 manufactured from the casing 10 by means of a cut that is positioned at a slant to the longitudinal axis 56 of the foodstuff product 4. In this connection, the outer shape of both halves as well as the orientation and position of the printed images 54, 54′ relative to the cut surfaces 58, 58′ are identical, respectively. A potential buyer or consumer of such a half of the foodstuff product 4 or of such a foodstuff product with slanted cut surface 58, 58′ can visually determine at first glance the contents of the foodstuff product 4 and the information of the printed images 54, 54′. This is advantageous also when the foodstuff product 4 is offered in a packaging that is only partially transparent, not illustrated, wherein the transparent area of the packaging then shows the printed image 54, 54′ and the cut surface 58, 58′ or at least parts thereof. The printed image 54, 54′ is fixedly connected to the casing 10 and is therefore present during the entire life span of the food product 4.

What is claimed is:

1-40. (canceled)

41. An arrangement for producing foodstuff products with pasty stuffing, the arrangement comprising:
a stuffing device having a stuffing tube;
a casing into which a stuffing can be stuffed through the stuffing tube of the stuffing device, wherein the casing portion that is being stuffed draws additional casing material from a supply and wherein the casing has spaced-apart repeating markings;
a sensor device adapted to recognize the markings, wherein the sensor device, when the markings reach an activation position, sends an activation signal;
a closing device closing the end of a previously stuffed casing portion and the beginning of a next casing portion to be stuffed after completion of stuffing of a final stuffing quantity;
an immobilization brake having a stop position in which drawing of the casing is completely prevented;
a first connection connecting the sensor device and the immobilization brake;
a second connection connecting the stuffing device and the immobilization brake;
wherein through the first connection the activation signal causes the immobilization brake to remain in the stop position until the stuffing device sends a termination signal to the immobilization brake through the second connection, wherein the termination signals indicates completion of stuffing of a preset stuffing quantity, wherein the preset stuffing quantity corresponds to a final stuffing quantity of the foodstuff product or portions of the final stuffing quantity.

42. The arrangement according to claim 41, wherein the immobilization brake comprises a pressing element that presses in the stop position the casing by a force load against a contact area of the stuffing tube.

43. The arrangement according to claim 42, wherein the pressing element annularly surrounds the stuffing tube.

44. The arrangement according to claim 42, wherein the pressing element is configured to be substantially slidable parallel to the longitudinal axis of the stuffing tube and forces in the stop position the casing in a sliding direction with a force load against the contact area of the stuffing tube.

45. The arrangement according to claim 42, wherein the pressing element has a pressing surface and the contact area has a contact surface, wherein the pressing surface is arranged essentially parallel to the contact surface.

46. The arrangement according to claim 45, wherein the pressing surface and the contact surface are conical.

47. The arrangement according to claim 42, further comprising a casing brake that has a drawing position in which a braked drawing action of the casing is possible.

48. The arrangement according to claim 47, wherein the immobilization brake is the same as the casing brake and is moveable into the stop position and the drawing position.

49. The arrangement according to claim 48, wherein the pressing element surrounds the stuffing tube annularly and the pressing element has an adjustable inner diameter.

50. The arrangement according to claim 41, wherein the stuffing device has a control controlling the stuffing quantity and the control is connected to the immobilization brake through the second connection.

51. The arrangement according to claim 50, further comprising a third connection connecting the sensor device to the control.

52. The arrangement according to claim 51, wherein the markings on the casing are different types of markings that are correlated in the control with a certain stuffing quantity, wherein the sensor device is configured to recognize the different types of marking, wherein, through the third connection, the sensor device signals to the control the type of marking.

53. The arrangement according to claim 41, wherein the sensor device is moveable parallel to a longitudinal axis of the stuffing tube.

54. The arrangement according to claim 41 wherein the sensor device has at least two spaced-apart sensors.

55. The arrangement according to claim 54, wherein the at least two spaced-apart sensors of the sensor device are configured to be movable away from and toward the stuffing tube.

56. A method for producing foodstuff products with pasty stuffing, the method comprising the steps of:
stuffing the stuffing into a casing that is closed at the beginning, is hose-shaped, and has spaced-apart repeating markings;
drawing additional casing material as the casing, carrying out a movement in a stuffing direction away from a stuffing location as the casing is being stuffed and causing the markings on the casing to reach an activation position;
stopping the step of drawing of additional casing material when the activation position is reached by one of the markings and continuing the step of stuffing until a preset stuffing quantity has been reached, wherein the preset stuffing quantity corresponds to a final stuffing quantity of the foodstuff product or portions thereof;
after the final stuffing quantity of the foodstuff product has been reached closing the end of the casing that has already been stuffed and the beginning of the casing to be stuffed next.

57. The method according to claim 56, wherein the casing, when the step of drawing is stopped, expands as the step of stuffing continues.

58. A casing for the arrangement according to claim 41, having spaced-apart repeating markings and a σ₅ value between 0.3 N/mm² and 25 N/mm².

59. The casing according to 58, wherein the markings each extend essentially about the entire circumference of the casing (10).

60. The casing according to claim 58, having printed images that are repeated at regular spacings.

61. The casing according to claim 60, wherein the markings are part of the printed images.

62. The casing according to claim 60, having a base coat onto which the printed images are applied.

63. The casing according to claim 58, wherein between two of the markings two identical printed images are provided that each have the same spacing to that one of the two markings that is proximal, respectively, wherein the two printed images are precisely opposite one another, when viewed circumferentially, on a foodstuff product produced with the casing and have a mirror-symmetrical orientation relative to one another.

64. The casing according to claim 58, wherein the casing is a hose or a flat material.

65. The casing according to claim 58, wherein the casing is closed at the beginning.

66. The casing according to claim 58 comprising a carrier material.

67. The casing according to claim 66, wherein the carrier material has a coating on one side or both sides of the casing.

68. The casing according to claim 66, wherein the markings and optionally printed images are printed onto the carrier material of the casing and the carrier material is provided with a transparent coating.

69. The casing according to claim 68, wherein the casing at least over areas thereof comprises a calendered textile base material.

70. The casing according to claim 69, wherein the markings comprise different types of markings.

71. A foodstuff product with pasty stuffing produced according to the method of claim 56, comprising a standardized stuffing quantity and a casing having a standardized length.

72. The foodstuff product according to claim 71, wherein the casing has at least one printed image and the at least one printed image is positioned at a defined spacing from one end of the foodstuff product.

73. The foodstuff product according to claim 71 having a cut surface extending at a slant to a longitudinal axis of the foodstuff product.

74. The foodstuff product according to claim 71, wherein the casing is the casing according to claim 58.
